(19) United States
(12) Patent Application Publication
(10) Pub. No.: US 2007/0174186 A1
(43) Pub. Date: Jul. 26, 2007

(54) AUTHENTICATED AND DISTRIBUTED TRANSACTION PROCESSING

(76) Inventor: Sean Hokland, Minneapolis, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/532,827

(22) Filed: Sep. 18, 2006

Related U.S. Application Data
(63) Continuation of application No. PCT/US05/09043, filed on Mar. 17, 2005.
(60) Provisional application No. 60/554,745, filed on Mar. 18, 2004.

(51) Int. Cl. G06Q 40/00

(52) U.S. Cl. 705/39

(57) ABSTRACT

An integrity network is used to authorize electronic transfer of funds between two entities such as a caller or user and a third party. The network is accessed by a user via an electronic device that is capable of transmitting voice, such as a telephone. The network uses voice recognition functions, and optionally other information to uniquely identify the user and hence guarantee the integrity of transactions. In one embodiment, a user's phone number, a cellular phone serial number, or other code can be used as a security token. A person called via the network can further validate the identity of the user. Once validated, the user becomes a trusted member of the integrity network. Financial product can be provided to the trusted member with guarantees to the network of the identity of the trusted member.

### PRIORITY

This application is a continuation under 35 U.S.C. 111(a) of PCT/US2005/009043 filed on Mar. 17, 2005, and published in English on Sep. 29, 2005 as WO 2005/091145, which claims the benefit under 35 U.S.C. 119(e) of U.S. Provisional Application Ser. No. 60/554,745, filed Mar. 18, 2004, which applications and publication are incorporated herein by reference.

### FIELD OF THE INVENTION

The present invention relates to point of sale transaction processing, and in particular to authenticated and distributed point of sale transaction processing.

### BACKGROUND OF THE INVENTION

Economic interactions are currently done by several conventional means. Money needs to flow between two parties in many such interactions, whether it be the purchase of an item from a commercial establishment, or an interaction between two individuals. Many interactions are done with checks, money orders, credit cards, electronic funds transfer, debit cards, and physical point of sale devices that accept cash. However, some of these methods are not available to millions of individuals with limited funds that their disposal. Some individuals may not have sufficient credit for a credit card, and lack sufficient funds for a lower cost savings or checking account. Still further difficulties arise from geographical limitations, where such methods of financial interaction are not feasible.

EFT, electronic funds transfer, is usually used within the same country of origin. ACH stands for Automated Clearing House or more commonly it is referred to as Wire Transfer. ACH is used for larger transactions and tends to be used for international transactions, though that's not strictly the case. The important difference is that EFT costs pennies per transaction, while ACH or Wire Transfer costs a few dollars.

A further problem with current methods of financial interactions involve security. Global financial institutions regularly experience fraud. Individuals and not uniquely accountable. Credit cards are subject to fraud, such as identity theft. There is a general lack of financial security for many transactions. EFT delivers money electronically through the banking system. It is used when payment must be made directly to a specified bank account rather than through the medium of a regular paper warrant. Wire transfers are generally done when a warrant is not easily redeemable in the Payee's country or when the Payee needs to be paid very quickly. Wire transfers can be used to make payments in U.S. dollars or in most (but not all) foreign currencies. It takes about two days (sometimes longer, for international wires) from initiation of the wire transfer by the Treasurer's Office to receipt of the money by the Payee's bank.

A foreign draft is done when the Payee's banking information is not available to do a wire transfer. Foreign drafts deliver money physically, through the mail system: they are paper documents. Foreign drafts are drawn on foreign banks and are payable in that bank's local currency or in U.S. dollars. There is a significant amount of security used to conduct such transactions. Information that may be required includes the name of payee—the person/entity whose account will receive the wire transfer (i.e., the bank account owner, or beneficiary), address of bank account owner, currency desired and amount to transfer (e.g., 1000 U.S. dollars, 5000 Euros). For domestic wire transfers, the information includes the name and address of payee's financial institution, its ABA or Routing and Transit Number, and bank account number receiving the funds. For international wire transfers, information includes the name and address of payee's financial institution, the S.W.I.F.T. identifier of the financial institution (if known), the receiving financial institution's United States correspondent bank (if applicable), or other means of completely and accurately identifying the payee's foreign financial institution, and bank account number receiving the funds.

Many of these transactions cost too much, and involve too much overhead for millions of people who desire to transfer money is small amount, and don't have access to conventional financial mechanisms.

### SUMMARY OF THE INVENTION

An integrity network is used to authenticate electronic transfer of funds between two entities such as a caller or user and a third party. The network is accessed by a user via electronic device that is capable of transmitting voice, such as a telephone. The network uses voice recognition functions, and optionally other information to uniquely identify the user and hence guarantee the integrity of transactions. In one embodiment, a user's phone number, a cellular phone serial number, or other code can be used as a security token. A person called via the network can further validate the identity of the user.

Once validated, the user becomes a trusted member of the integrity network. Any financial product can be provided to the trusted member with guarantees to the network of the identity of the trusted member. Such guaranteed identity provides for much better traceability of transactions and a more robust and trustworthy access to the customer.

In one embodiment, a user initiates a transaction by calling the integrity network, which may be implemented by a computer program running on a telephony switch. The integrity network provides automated voice recognition for pre-registered users to authenticate the user as a trusted member of the network. The network then asks the trusted member for an account number. The account number may be for a checking account, a credit card, or any other type of account such as a deposit/debit account managed for the trusted user by the network.

The trusted member then requests a link or call to a third party by providing a phone number and optionally a method of billing for the call. The third party may be a trusted member or not. If not, the third party is queried for details to support financial reporting obligations. Such query may request voice print and other contact information. The third party also provides an account number. An electronic funds transfer is then initiated by the integrity network from the trusted member's account to the third party account, or from the third party account to the trusted member's account. In one embodiment, the integrity network mutes identification of account numbers to prevent disclosure of the account number to one of the callers.

### BRIEF DESCRIPTION OF THE DRAWINGS

FIG. 1 is a block diagram of a system and environment for performing financial transactions between customers according to an embodiment of the invention.

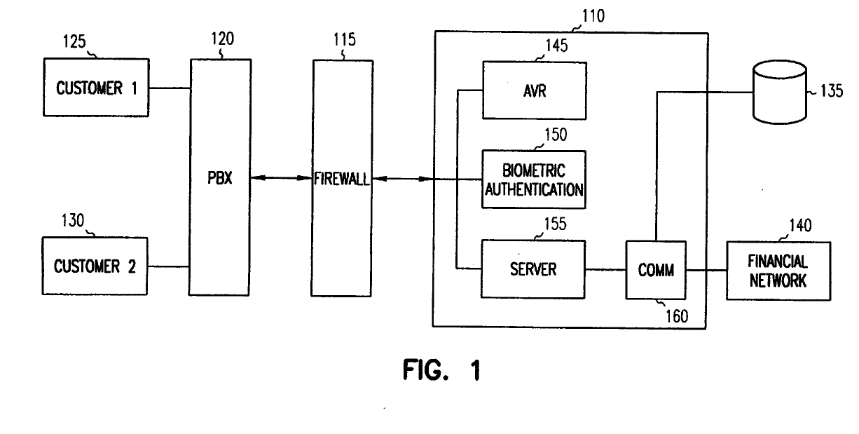

FIG. 2 is a flowchart of one example financial transaction utilizing the system of FIG. 1.

FIG. 3 is a flowchart of a further example financial transaction utilizing the system of FIG. 1.

FIG. 4 is a flowchart of yet a further example financial transaction utilizing the system of FIG. 1.

FIG. 5 is a block diagram of an example computer system for executing computer programs implementing different embodiments of the invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

A system for facilitating a financial transaction, such as transferring funds between a user account and a third party account is shown at 110. The system is coupled through a firewall 115 to a telephony switch, such as a private branch exchange (PBX) 120. A first user or customer indicated at 125 initiates the financial transaction by calling the system through a cellular phone or other telephony device. The call is handled by the switch 120. The customer provides the system 110 details of the transaction, and also identifies another third party or customer 130, who is also coupled to the system 110 via switch 120.

System 110 is also coupled to a database 135 and a financial network 140 for executing transactions identified by the customers. Database 135, such as an SQL based server, contains verification information about the customers, such as voice prints and other background data provided during a registration of one or more of the customers. Such information may also be stored locally on system 110.

In one embodiment, system 110 comprises an automated voice recognition system (AVR) 145, a biometric authentication module or program 150 and a server 155. AVR 145 provides a convenient user interface by providing a voice driven menu based data collection mechanism. In other words, it uses voice to inform a user when to provide a voice print, asks questions, provides text of responses for comparison with information in the database, and asks for transaction information, and third party information.

Server 155 is coupled to a communication module 160 for connection to the financial network 140 and external database 135. Communication module 160 may be a wireless network card with software, or any other type of communication hardware and software for facilitating connection to a network, such as the Internet.

In one embodiment, the financial network utilizes Electronic Funds Transfer (EFT). EFT is a system of transferring money from one bank account directly to another without any paper money changing hands. One of the most widely-used EFT programs is Direct Deposit, in which payroll is deposited straight into an employee's bank account, although EFT refers to any transfer of funds initiated through an electronic terminal, including credit card, ATM, Fedwire and point-of-sale (POS) transactions. It is used for both credit transfers, such as payroll payments, and for debit transfers, such as mortgage payments.

Transactions are processed by the bank through the Automated Clearing House (ACH) network, the secure transfer system that connects all U.S. financial institutions. For payments, funds are transferred electronically from one bank account to the billing company's bank, usually less than a day after the scheduled payment date.

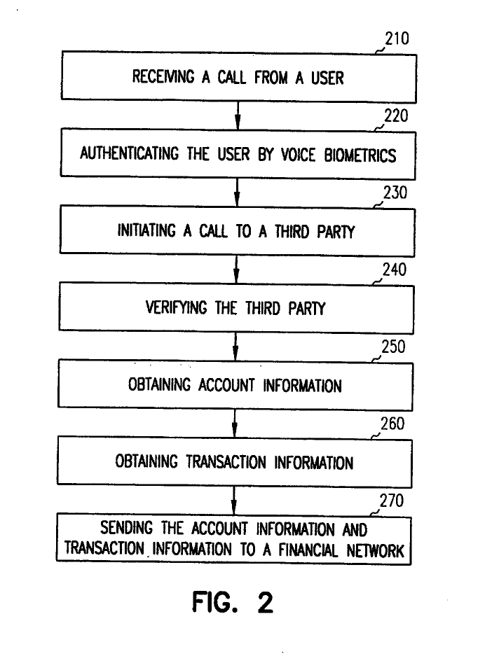

One example transaction using system 110 is illustrated in the flowchart of FIG. 2. The transaction involves transferring funds between a user account and a third party account. At 210, a user calls a predetermined phone number, and the system receives the call from the user. The user is then authenticated by use of voice biometrics 220. In one embodiment, the user is preregistered, and voice print is stored for such authentication. Other authentication methods may also be utilized. A call to the third party is then initiated at 230. The third party is then verified at 240. Such verification may also involve the use of voice biometrics and other methods.

Account information is then obtained at 250. The account information for both the user and third party may already be known to the system, or may be provided during the transaction. Information regarding the details of the transaction are then obtained at 260. Such details may include an amount, and an indication of the direction of the transfer of funds. At 270, the account and transaction information is sent to the financial network.

In one embodiment, the user and third party are pre-registered as trusted members. This allows the system to quickly verify the identity of each, and also to compile accurate information for required reporting. Pre-registering a user comprises obtaining a voice print and selected identification information in one embodiment. It may further include obtaining caller ID information, such as a cellular telephone number that can be used to contribute to verification of the user. Further embodiments utilize advanced telephony devices, including personal computers, that may be capable of providing data for finger prints, odor biometrics, facial recognition biometrics and others. A “familiarity quotient” is based on a scale representative of how well a customer is trusted, and how well the customer can be identified using the above varieties of biometrics and other information. The higher the familiarity quotient, the higher the transaction limits available to a customer.

The account information used in the transaction comprises an account number. The account may be any type of account compatible with an electronic funds transfer network, such as checking, saving, brokerage, credit card, debit card, etc. In one embodiment, the account numbers are obtained during enrollment of the trusted members such that it need only be transmitted by phone once. In further embodiments, enrollment may be accomplished using secure network type resources. Once enrolled, sensitive financial information remains behind the firewall, in a secure environment.

In one embodiment, if the third party is pre-registered, they are verified at least by use of a voice print. If the third party is not pre-registered, a voice print is obtained along with identification information from the third party. Further verification of the identity of the third party may be provided by other trusted users to provide higher confidence of authentication. Such identity information ideally provides sufficient information for reporting requirements, and to trace transactions and hold users and third parties accountable.

In one embodiment, initiating a call to the third party comprises receiving a phone number from the user for the third party. The third party may also be identified by a different identifier, such as a name, and the phone number is known in the database.

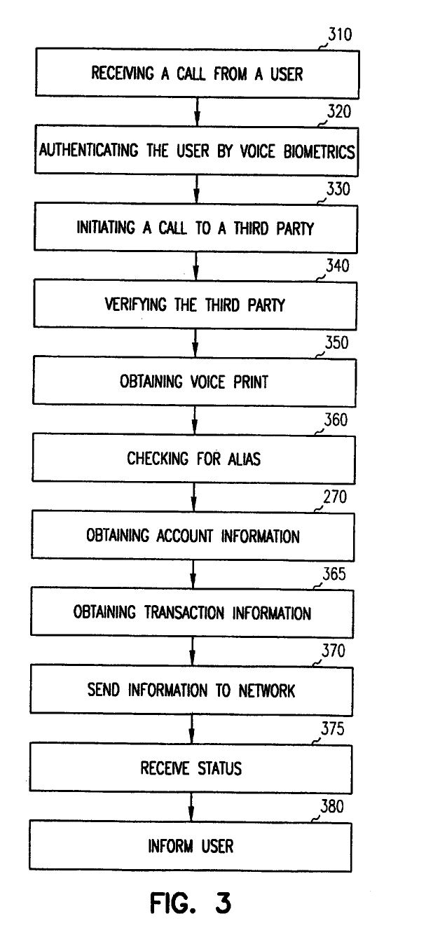

A further method of facilitating a financial transaction between a user and a third party, is shown in a flowchart in FIG. 3. At 310, a user calls a predetermined phone number, and the system receives the call from the user. The user is then authenticated by use of voice biometrics 320. In one embodiment, the user is preregistered, and voice print is stored for such authentication. Other authentication methods may also be utilized. A call to the third party is then initiated at 330. The third party is then verified at 340. Such verification may also involve the use of voice biometrics and other methods.

A voice print of the third party is obtained at 350. The voice print is optionally used to check for other names or aliases the party may have used in the past at 360. Both local and remote databases may be utilized for this checking. At 270, account information is obtained, either from a profile of already enrolled trusted member third party, or it may be provided directly by the third party during the transaction.

Transaction information is obtained at 365, identifying an amount of the transaction, or other information relevant to the transaction. At 370 a funds transfer request consistent with the transaction information and account numbers is sent to the financial network for execution at 370. The system may receive a status of the transaction at 375, and inform the user and third party at 380.

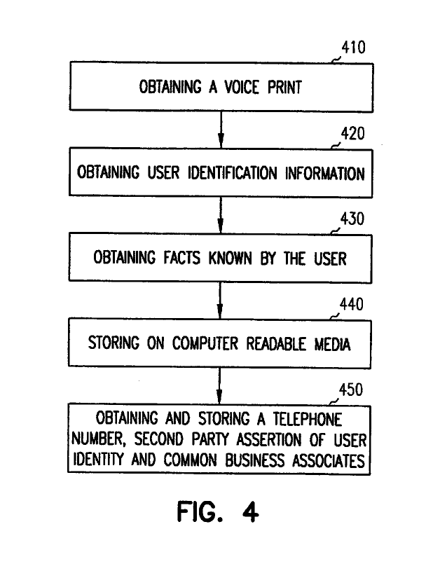

A method of enrolling a user as a trusted member for transferring funds is illustrated in a flowchart in FIG. 4. The method may be performed by individuals, or may be automated using volunteers or workers roaming the country side of third world countries with suitable equipment for collecting authentication information. Such enrollment comprises obtaining a voice print at 410, and obtaining user identification information at 420. The user identification information may include name, address, tax id, and other information used to identify an individual. Coincident with obtaining the voice print, other biometric information, such as fingerprint, odor biometrics, facial recognition biometrics and others may also be collected.

The collected information is stored on computer readable media 440. At 450, a telephone number, and assertion of user identity by currently trusted enrolled members may be utilized. Still further, common business associates identification may also be collected and stored.

In one embodiment, a remote data collection device, such as a personal digital assistant, personal computer, or cellular telephone is used to collect the information. The device may be directly coupled to a network, or connected to such a network at a later time for uploading the information. In still further embodiments, existing trusted members enroll new members using a cellular phone. The use of biometrics helps prevent fraud, and at a minimum provides good information for investigation of attempted fraud.

The integrity network may be used in many different settings. It may be used to replace the use of credit cards. Instead of scanning a credit card, a user may simply provide a voice print at a point of sale terminal, and perhaps answer some questions. Further biometrics may also be used at such point of sale terminals. The terminals may be based in grocery stores, gas stations, or one of thousands of different establishments. The caller ID of the terminals may be sufficient to identify the establishment as a trusted user/vendor.

In a further embodiment, the integrity network is used for distribution of aid. Users are enrolled as above to become trusted members. In this example embodiment, aid is distributed as a user is verified. Thus, an aid worker could have each person receiving aid be verified by the integrity network, and a database could also be used to track who has received such aid.

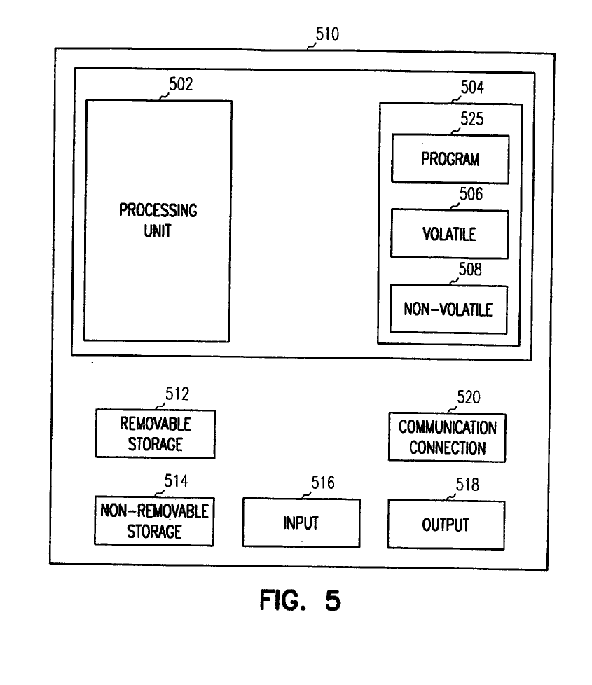

A block diagram of a computer system that executes programming for performing the above algorithms is shown in FIG. 5. A general computing device in the form of a computer 510, may include a processing unit 502, memory 504, removable storage 512, and non-removable storage 514. Memory 504 may include volatile memory 506 and non-volatile memory 508. Computer 510 may include—or have access to a computing environment that includes—a variety of computer-readable media, such as volatile memory 506 and non-volatile memory 508, removable storage 512 and non-removable storage 514. Computer storage includes RAM, ROM, EPROM & EEPROM, flash memory or other memory technologies, CD ROM, Digital Versatile Disks (DVD) or other optical disk storage, magnetic cassettes, magnetic tape, magnetic disk storage or other magnetic storage devices, or any other medium capable of storing computer-readable instructions. Computer 510 may include or have access to a computing environment that includes input 516, output 518, and a communication connection 520. The computer may operate in a networked environment using a communication connection to connect to one or more remote computers. The remote computer may include a personal computer, server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 505 of the computer 510. A hard drive, CD-ROM, and RAM are some examples of articles including a computer-readable medium. For example, a computer program 525 capable of providing a generic technique to perform access control check for data access and/or for doing an operation on one of the servers in a COM based system according to the teachings of the present invention may be included on a CD-ROM and loaded from the CD-ROM to a hard drive. The computer-readable instructions allow computer system 200 to provide generic access controls in a COM based computer network system having multiple users and servers.

All publications, patents and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

1. A method of transferring funds between a user account and a third party account, the method comprising:
receiving a call from the user;
authenticating the user by use of voice biometrics;
initiating a call to the third party;
verifying the third party;
obtaining account information;
obtaining transaction information; and
sending the account information and transaction information to a financial network.

2. The method of claim 1 and further comprising pre-registering a user as a trusted member.

3. The method of claim 2 wherein pre-registering a user comprises obtaining a voice print and selected identification information.

4. The method of claim 1 wherein the method is implemented on a telephony switch.

5. The method of claim 1 wherein the account information comprises an account number.

6. The method of claim 1 wherein the transaction information comprises an amount of money to transfer between accounts.

7. The method of claim 1 wherein if the third party is pre-registered, verifying the third party by use of a voice print.

8. The method of claim 1 wherein if the third party is not pre-registered, obtaining a voice print and identification information from the third party.

9. The method of claim 1 wherein obtaining account information comprises obtaining a user account number from the user and obtaining a third party account number from the third party.

10. The method of claim 1 wherein initiating a call to the third party comprises receiving a phone number from the user.

11. The method of claim 1 wherein initiating a call to the third party comprises receiving an identifier, and looking up a phone number for the third party.

12. The method of claim 1 and further comprising authenticating the user by caller ID.

13. A method of facilitating a financial transaction between a user and a third party, the method comprising:
receiving a call from the user;
authenticating the user by use of voice biometrics;
initiating a call to the third party;
verifying the third party;
obtaining account information;
obtaining transaction information;
sending the account information and transaction information to a financial network;
receiving an indication of the status of the transaction; and
informing the user of such status.

14. The method of claim 13 wherein authenticating the user further comprises:
receiving a voice print of the user; and
checking a database for alias detection.

15. A method of transferring funds between a user account and a third party account, the method comprising:
receiving a call from the user;
authenticating the user by use of a voice print, content of the voice print, and stress levels in the voice print;
initiating a call to the third party;
verifying the third party;
obtaining account information;
obtaining transaction information; and sending the account information and transaction information to a financial network.

16. A method of enrolling a user as a trusted member for transferring funds between an account of the user and a third party account, the method comprising:
obtaining a voice print of the user;
obtaining user identification information;
obtaining facts known by the user; and
storing the voice print, identification information and known facts on a computer readable media.

17. The method of claim 16 and further comprising obtaining and storing a telephone number, second party assertion of the user identity, and common business associates.

18. A system for transferring funds between a user account and a third party account, the system comprising:
a server coupled to a telephony switch that receives a phone call from a user and a voiceprint of the user;
an authorization database having stored biometrics and user information used by the server to authenticate the user based on the voiceprint;
a module that receives financial information from the user and generates a data structure representative of a financial transaction; and
a module the sends the data structure to a financial network for execution of the financial transaction.

19. The system of claim 18 and further comprising a module that notifies the user when the transaction is completed.

20. A device for transferring funds between a user account and a third party account, the device comprising:
means for receiving a call from the user;
means for authenticating the user by use of voice biometrics;
means for initiating a call to the third party;
means for verifying the third party;
means for obtaining account information;
means for obtaining transaction information; and
means for sending the account information and transaction information to a financial network.

21. A computer readable medium having instructions for causing a computer to execute a method of transferring funds between a user account and a third party account, the method comprising:
receiving a call from the user;
authenticating the user by use of voice biometrics;
initiating a call to the third party;
verifying the third party;
obtaining account information;
obtaining transaction information; and
sending the account information and transaction information to a financial network.
